(19) United States
(12) Patent Application Publication
(10) Pub. No.: US 2007/0231430 A1
(43) Pub. Date: Oct. 4, 2007

(54) Extinguisher food product and method of manufacture

(76) Inventors: Matthew P.d. Brown, Berkeley, CA (US); Adam DeVito, Sausalito, CA (US); Charlotte Albright, Mill Valley, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/656,652

(22) Filed: Jan. 23, 2007

Related U.S. Application Data
(60) Provisional application No. 60/761,983, filed on Jan. 24, 2006.
(60) Provisional application No. 60/850,616, filed on Oct. 10, 2006.

(51) Int. Cl. A23L 1/09; A23L 1/22; A23L 2/02

(52) U.S. Cl. 426/78; 426/103; 426/416; 426/443; 426/533; 426/599; 426/650; 426/89

(57) ABSTRACT

An extinguisher food product is provided in which the intensity level of each piece of food product is controlled. The intensity level of each piece may be a sourness level or a spiciness level. The extinguisher food product may be a hard candy, fruit snack or other snack products.

### PRIORITY CLAIMS/RELATED APPLICATIONS

This application claims priority under 35 USC 119(e) and 120 to U.S. Provisional Patent Application Ser. No. 60/761,983, filed on January 24, 2006 entitled “Extinguisher Candy and Method of Manufacture” and to U.S. Provisional Patent Application Ser. No. 60/850,616 filed on Oct. 10, 2006 entitled “Extinguisher Food Product and Method of Manufacture”, both of which are incorporated herein by reference.

### FIELD OF THE INVENTION

The invention relates generally to a food product and its method of manufacture.

### BACKGROUND OF THE INVENTION

There are many food products, such as fruit snacks, spicy treats and sour food products, available on the market today. For example, there are many known sour candies on the market today such as Sour Tarts, Sour Patch Kids and the like. For each of these different food products, the food product has been designed to have a specific amount or level of sourness. However, none of these existing food products have a plurality of pieces of food product wherein each piece of food product has a different (increased or decreased) level of taste intensity wherein the taste intensity may be sourness or spiciness. In addition, none of these existing food products including candies have a piece of food product that can reduce the taste intensity of the other pieces of food products. It is desirable to provide a food product that has multiple pieces of food products with different levels of intensity and a piece of food product that can reduce the intensity of the other pieces of the food product.

Conventionally, a sour food product is made by a process in which sugar is cooked and an acid is added at the end of the cooking process or acid is added to the exterior of the food product. The problem with these conventional sour food product is that the mixture of sugar used as a base, heat (to cook the food product) and acid (to make the food product sour) contribute to an inversion of sugar which greatly shortens the shelf life of the food product, such as candy. The inversion of sugar is the conversion of sucrose to glucose and fructose, resulting in the liquefaction of the “sugars” in the food product. This liquefaction of the food product makes it unsuitable for normal distribution because it causes the food product to soften or liquefy within several weeks or months. Sugar inversion is directly proportional to the amount of hydrogen ions present in the food product wherein the inversion of sugar occurs more quickly when more hydrogen ions are present. In a sour food product, as the pH drops (i.e. as the sour level increases) the rate of inversion increases. Furthermore, the heat and humidity in the cooking process and in the ambient environment in which the final product rests can accelerate this inversion process. It is desirable to produce a sour food product that reduces the inversion of sugar so that the sour food product has a longer shelf life.

In addition, it is desirable to create other food products that have high intensity, such as high sourness or spiciness. Thus, it is desirable to have a high intensity food product that has a piece of food product that can reduce the intensity or extinguish the intensity of the food product and a method for manufacturing the extinguisher food product. It is to this end that the present invention is directed.

### BRIEF DESCRIPTION OF THE DRAWINGS

FIG. 1 illustrates an extinguisher food product;

FIG. 2 illustrates an example of an embodiment of the extinguisher food product;

FIGS. 3A and 3B illustrate an example of another embodiment of the extinguisher food product;

FIG. 4 illustrates an example of another embodiment of the extinguisher food product;

FIG. 5 illustrates an example of another embodiment of the extinguisher food product that may be a hard candy; and

FIG. 6 illustrates an embodiment of a method for manufacturing the extinguisher hard candy shown in FIG. 5.

### DETAILED DESCRIPTION OF SEVERAL EMBODIMENTS

The invention is particularly applicable to a sour extinguisher food product with the particular pieces of food product and method of manufacture set forth below and it is in this context that the invention will be described. It will be appreciated, however, that the extinguisher food product in accordance with the invention has greater utility since the extinguisher food product may be made with a different number of pieces of food product (from 1 to hundreds) wherein each different piece of food product has a different intensity level (which may be sourness or spiciness), may be made with different ingredients/components and may be made with different manufacturing techniques and those changes are within the scope of the invention as those changes would be known to one of ordinary skill in the art.

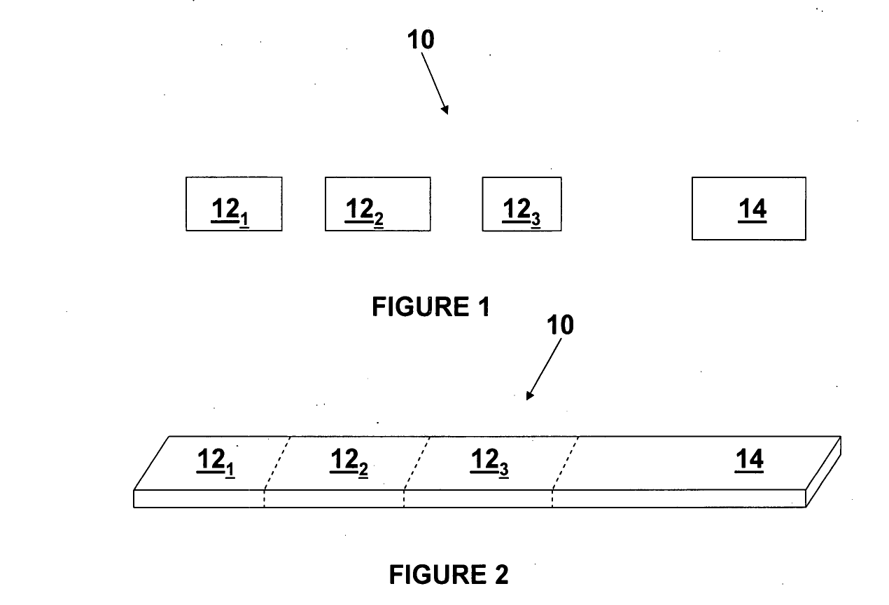

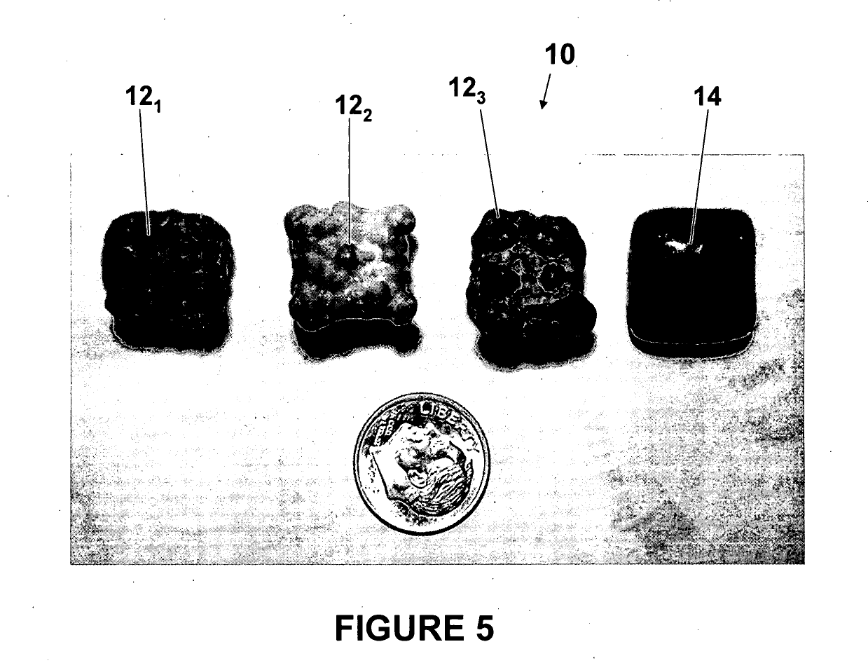

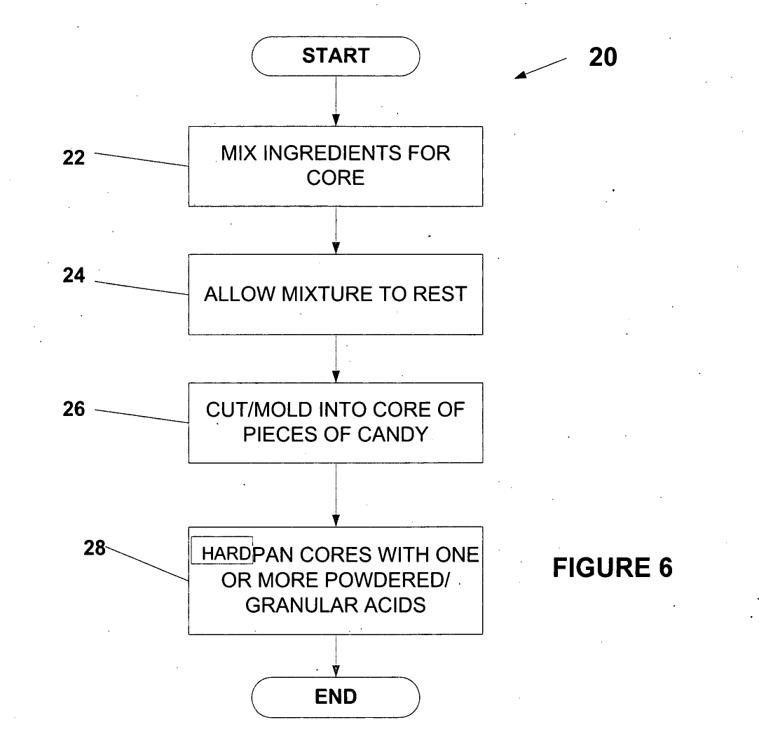

FIG. 1 illustrates an extinguisher food product 10 wherein the food product has one or more pieces 12 (12₁-12₃ shown in the example in FIG. 1) with different intensity levels and an extinguisher piece 14. The different intensity levels may be increasing levels of a characteristics of the food product, such as sourness or spiciness of each piece of the food product. The extinguisher piece 14 may counteract/reduce the effect of the other pieces 12. For example, for a food product with different sourness levels, the extinguisher piece 14 may be a juicy and/or sweet piece that quickly counteracts the effects of the sour pieces. The extinguisher food product may be various different types of food products and some examples of the different types of food products are described below with an exemplary embodiment of the extinguisher food product being a snack or a hard candy as described in more detail below with reference to FIGS. 5 and 6.

The extinguisher food product snack also may be a fruit snack or other snack and can be a chewy snack, such as licorice, a gummy or “chew”/taffy-like texture. The snack may also be one or more pieces of gum. The snack may be fortified in some way and use some amount of real fruit or fruit juice. The snack can be manufactured in various formats. For example, the snack can be made as strips, twisted strips, pieces, a roll or a snack that has a liquid center that is released when the person eating the snack bites into the snack. The intensity levels of the pieces of the snack may be formulated to be contained in each piece, but the components that change the intensity level of each piece of the snack can also be applied to an outer surface of the snack such as by using a coating or a dusting.

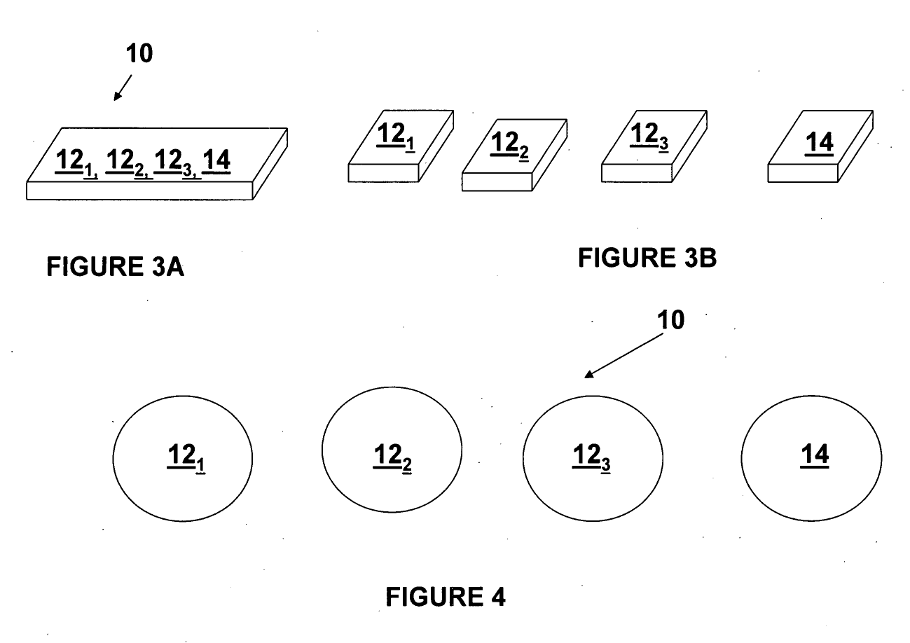

FIG. 2 illustrates an example of an embodiment of the extinguisher food product 10 that is a snack. In this example, the snack is a continuous strip of food product (that may be, for example, rolled up when sold to a user) wherein different portions of the strip each have a different intensity level (when that portion of the strip is consumed by the user) as shown in FIG. 2 (with the separations of the different portions illustrated by the dotted lines that are not present in the actual food product) and the strip also has an extinguisher portion 14. Alternatively, the different intensity levels of the portions of the strip can be adjusted by a powder added onto the strip after the strip is manufactured. In one example, the strip may be a fruit snack. FIGS. 3A and 3B illustrate an example of another embodiment of the extinguisher food product 10 wherein the food product is one or more pieces of gum (formed as a single piece as shown in FIG. 3A or formed as separate pieces as shown in FIG. 3B) wherein one or more pieces of gum 12₁-12₃ have one or more intensity levels and there is also an extinguisher piece of gum 14 that has the same characteristics as the extinguisher food product described above. FIG. 4 illustrates an example of another embodiment of the extinguisher food product 10 wherein the food product has one or more pieces that may be, for example, snack pieces. Each piece may have a liquid center/core wherein the liquid center is released when the piece is chewed. The intensity levels of the snack pieces 12₁-12₃ may be due to the components of the snack piece or may be due to the liquid contents. Similarly, there may be an extinguisher piece 14 that counteracts/reduces the intensity level of the other pieces wherein the extinguisher property of this piece is due to the components of the snack piece or may be due to the liquid contents. In one example, the pieces may be fruit pieces. Now, an example of the hard candy embodiment of the extinguisher food product is described in more detail.

FIG. 5 illustrates an example of another embodiment of an extinguisher food product that may be a hard candy. In this example, four pieces of candy 12₁-14 (with pieces 12₁-12₃ having a different level of intensity and piece 14 being the extinguisher piece) are shown for illustration purposes although the extinguisher food product may have a plurality of pieces of candy in a container/packet wherein the plurality of pieces of candy are selected from the four different pieces of candies 12₁-14 shown in FIG. 5. In this example, each piece of candy 12₁-12₃ may have a different sourness level. For example, a first piece 12₁ of candy has a low sourness level, a second piece 12₂ of candy has a medium sourness level and a third piece 12₃ of candy has a high sourness level. For example, each piece of candy may have a different pH level due to the different acid(s) contained in each piece of candy. A fourth piece 14 of candy is the extinguisher piece that counteracts/reduces the effect of the sour pieces of candy. For example, the extinguisher piece 14 may be a juicy and/or sweet candy that quickly counteracts the effects of the sour candies.

In one embodiment, the extinguisher food product may be known as “Sour Extinguisher” candy and may provide a flavorful, interactive and participatory play experience. The market has a need for this play experience using the extinguisher food product and the extinguisher food product fulfills that need. The Sour Extinguisher may include four fruit flavors/colors including three sour fruit flavors of Tangy Tangerine, Super Sour Lemon and Tongue Twisting Lime with increasing levels of sourness. For example, the Super Sour Lemon will be very sour for many children and Tongue Twisting Lime will be extremely sour for the person eating the piece of candy. As children eat the various sour flavors, they can create a variety of sour level experiences. Then, once they have achieved the desired sour level, or reached their maximum tolerance, they can eat a Cool Blue Raspberry extinguisher piece to quickly douse the sourness of the other pieces of candy thereby providing the play experience not available in the market As shown in FIG. 5, in one embodiment, the sour pieces of candy 12₁-12₃ are bumpy while the extinguisher piece 14 is smoother. The dime shown in FIG. 5 illustrates the size of the pieces of candy shown in FIG. 5 although the invention is not limited to any particular size for each piece of candy or food product.

The “Challenge” for the play experience using the extinguisher food product is to see if the eater can “make it through” all of the sour levels (three in the exemplary embodiment). Then, the extinguisher candy can be eaten by the child who either can't “make it through” all of the sour levels (and needs sour relief) or when the child has made it through all of the sour levels and eats the extinguisher candy as a reward. Furthermore, combining the highest sour level pieces of candy (such as by eating more than one piece of candy at the same time) can create an “extreme” sour experience for the ultimate challenge. The extinguisher candy uniquely calls upon a child's competitive instinct with themselves, their peers and/or their parents. The game play experience variations provided by the extinguisher food product/candy may include: 1) can you handle the intensity level of the pieces of food product and then consume the extinguisher piece to reduce the intensity level once the person has reached his taste intensity limit; 2) combine the pieces of candy to create more intense taste levels and then consume the extinguisher piece to reduce the intensity level once the person has reached his taste intensity limit; and 3) a social play experience in which people are each handed a random piece of the different intensity level pieces and then see who can handle the intensity level of the piece being eaten. Now, a method for producing the extinguisher candy will be described in more detail.

FIG. 6 illustrates an embodiment of a method 20 for manufacturing the extinguisher candy shown in FIG. 5. In this manufacturing method for sour candies, a cold blended process (no heat is used to cook the candy) is used to make a chewy candy core which is then coated with a dextrose/glucose syrup and powdered/granular acid mixture using a hard pan process as described below that achieves the high levels of sourness that are present in the extinguisher candy wherein the cold, blended process may be a cold gum factory process. This process, modified as set forth below, and the unique blend of ingredients for the candy create a shelf-stable, very sour candy. In an alternative method, the cores may be cooked while diminishing the risk of inversion. The cold center process is preferable as it likely allows for more acid in the core than a cooked core. However, making a cooked, chewy center and then coating or sealing the center with one or more substances, such as gum Arabic, then panning as described below may also be used to create the extinguisher food product. This sealing of the cooked center will diminish risk of inversion by preventing migration of sugars and acid between the core and the coating.

For both the cold process and the cooked process, the manufacturing process of the extinguisher candy overcomes the problem of reduced shelf life described above for typical sour candies by retarding the sugar inversion. Thus, the manufacturing process results in reducing sugar inversion which in turn results in less hydrolysis and therefore an increase in shelf life over the conventional sour candies.

As shown in FIG. 6, the manufacturing process 20 may include a step 22 of mixing the components/ingredients of the extinguisher candy core. The extinguisher candy core is made from a mixture of sugar, corn syrup, one or more acids and instant granular starches that require little or no heat to gel. In particular, the formulation is a unique blend of instant starches (such as Staley's Mira-Thik 468 and Mira-Thik 603 which are commercially available), one or more acids, corn syrup, maltodextrin, gelatin, and sugar that can be mixed without heat to result in a chewy texture and a sour flavor without concern of the candy going into hydrolysis. The candy is formulated at the finished moisture content thereby eliminating any need for evaporative cooking.

In step 24, the mixed ingredients for the cores of the candy are permitted to rest for a specified period of time (preferably 2-3 hours) prior to being cut or molded into shape which is a novel process step for manufacturing a sour candy. This step allows for the moisture levels to stabilize, thereby, reducing the incidence of cold flow which is the movement of a candy from one shape to another with no external forces (other than gravity) acting thereon. In step 26, once the mixed ingredients have rested, the core of each piece of candy is produced by forming and/or cutting the mixed ingredients into pieces. In one embodiment, each piece of sour candy 121-123 may be manufactured using the same core (to reduce manufacturing costs), but it is also possible to make each piece of candy 12₁-12₃ with a different core wherein each core for each piece of candy has a different level of sourness by using one or more acids (as described below) for each core. In addition, extinguisher piece may be manufactured using its own core.

In step 28, once the cores of the pieces of candy are made, the cores for the sour pieces may be put through a hard panning process. The hard panning process in conjunction with the one or more acids as described below produce the bumpy pieces of candy as shown in FIG. 5 that have the desired level of sourness. During the hard panning process, the cores are placed into a hard panning unit that agitates the cores while coating them with a mixture of glucose/dextrose and one or more granular/powdered acids wherein the mixture dries and forms a shell over the core that has a desired level of sourness since the one or more granular/powdered acids are trapped into the dried shell. The process of forming the shell over the core may be repeated multiple times (up to 10 times) to create the desired piece of candy. The manufacturing process may also include a step, once the hard panning is completed, of coating each piece of candy with a hard layer over the shell layers to improve the shelf life of the pieces of candy and protect the pieces of candy from moisture. The core for the extinguisher piece is not hard panned, but may be coated with the hard layer to improve the shelf life of the pieces of candy and protect the pieces of candy from moisture.

In order to achieve the desired sourness of the extinguisher candy, one or more acids are used wherein prolonged sourness and/or tartness is achieved because of an overlap of the acid release times. In more detail, a mixture of different types of acids results in a sequential acid release of sourness and tartness that work with the citrus profile of the flavors. The multiple acids provide an extinguisher candy with an optimal taste for a specific period of time. In an exemplary embodiment, the extinguisher candy may use four different acids (including tartaric acid, citric acid, lactic acid and fumaric acid) to create a different sour sensation and intensity level in the mouth. The tartaric acid creates an immediate spike of sour and tartness. Then, as the tartaric acid starts to fade, the citric acid is sharp, astringent and works best with citrus flavors. The lactic acid (milder but lingering) elongates the sour sensation as does the fumaric acid which has a delayed but “clean” tartness. For the Sour Extinguisher example set forth above, the Tangy Tangerine piece contains only the citric acid, the Super Sour Lemon piece contains the citric and fumaric acids (and the fumaric acid in powdered/granular form is used during the hard panning process to coat the core) and the Tongue Twisting Lime piece (the sourest piece) uses citric, fumaric and tartaric acids (and the fumaric and tartaric acids in powdered/granular form are used during the hard panning process to coat the core).

For the exemplary embodiment of the extinguisher candy (the Sour Extinguisher), each piece of sour candy (Tangy Tangerine, Super Sour Lemon and Tongue Twisting Lime) may have the following ingredients (as an approximate percentage of the total ingredients in each piece of candy wherein the total percentage may be slightly more than or less than 100 due to rounding off of the percentages for each ingredient) in the core and in the shell of each piece of candy:

TABLE 1
INGREDIENTS FOR EXEMPLARY SOUR PIECES OF CANDY

| | Percentage By Weight | | | |
|---|---|---|---|---|
| | | | Lemon | Tangerine |
| | | Lime Piece | Piece | Piece |
| Ingredient | Core | Shell | Shell | Shell |
| Sugar | 29 | | | |
| Corn Syrup | 15 | | | |
| Dextrose | 17-23 | | | |
| Modified Food Starch (468) | 4.5 | | | |
| Modified Food Starch (606) | 8.9 | | | |
| Maltodextrin | 6 | | | |
| Citric Acid | 4.2-6.7 | | | |
| Potassium Citrate | 1.5 | | | |
| Gelatin | 2.2 | | | |
| Palm Oil | 1.5 | | | |
| Soy Lecithin | 0.2 | | | |
| Flavor | 0.2-0.6 | | | |
| Lactic Acid | | | | |
| Tartaric Acid | | 2.4 | | |
| Fumaric Acid | | 1.8 | 0.8 | |
| Color - Titanium Dioxide | | 0.1 | 0.1 | 0.1 |
| Yellow 5 | | 0.0144 | 0.075 | |
| Yellow 6 | | | | 0.02 |
| Blue 1 | | .003 | | |

The core of each piece of candy in Table 1 has the same ingredients, but the percentages for each different piece of candy are different since each candy has a different coating (coated onto each piece of candy during the hard panning process) which affects the percentage for each ingredient. In addition, the formulation set forth in Tables 1 and 2 are merely an example of the formulation of each piece of candy and the invention is not limited to the particular formulation set forth in Tables 1 and 2. In this example, the least sour piece of candy has one type of acid, the middle level of sourness piece of candy has two types of acid and the most sour piece of candy has four types of acid which partially accounts for the different levels of sourness for each piece of candy.

The extinguisher piece of candy (Cool Blue Raspberry) may have the following ingredients (again as a percentage of the total ingredients in the piece of candy wherein the total percentage may be slightly more than or less than 100 due to rounding off of the percentages for each ingredient) in the core and in the shell of the extinguisher piece of candy:

TABLE 2
INGREDIENTS FOR EXEMPLARY EXTINGUISHER
PIECE OF CANDY

Percentage by Weight

| Ingredient | Core | Shell |
|---|---|---|
| Sugar | 41 | |
| Corn Syrup | 22.765 | |
| Dextrose | 18 | |
| Modified Food Starch | 6 | |
| (468) | | |
| Maltodextrin | 5.9 | |
| Citric Acid | 0.5 | |
| Potassium Citrate | 0.25 | |
| Gelatin | 1.2 | |
| Palm Oil | 4 | |
| Soy Lecithin | 0.1 | |
| Flavor | 0.1 | |
| Color - Titanium Dioxide | | 0.18 |
| Blue 1 | | .002 |
| Red 40 | | .003 |

As with Table 1, Table 2 shows the ingredients listed as a percentage of the total weight of the extinguisher piece of candy.

In an alternative embodiment of the invention, during the manufacturing process, a first set of mixed ingredients, a second set of mixed ingredients, a third set of mixed ingredients and a fourth set of mixed ingredients may be formed wherein the three different sourness level pieces of candy are produced from the first, second and third set of mixed ingredients, respectively and the extinguisher candy is made from the fourth set of mixed ingredients since each different piece of candy has a slightly different set of ingredients for the core. If an extinguisher candy with a different number of sour pieces of candy or a different extinguisher candy (such as a drink extinguisher), then a different number of sets of mixed ingredients may be generated during the manufacturing process and those different number of sets of mixed ingredients are within the scope of the invention.

In the above manufacturing process, to make the piece of the extinguisher candy extremely sour and prevent sucrose inversion, the process minimizes the exposure of the extinguisher candy to high temperatures (when using the cold process), uses ingredients in dry, powdered or granular form to reduce moisture in the final product, adds buffer salts such as citrates or lactates and hard pans with a very high level/mix of hydrophobic acids. When using a cooked core process, the core is sealed to prevent the sucrose inversion.

In alternative embodiments, the extinguisher candy may also have any number of piece of candy with each piece of candy having a different level of sourness wherein three levels is preferred (as described above), but 2 or more levels of sourness may be used for the extinguisher candy. In another alternative embodiment, the extinguisher candy may use the sour pieces of candy as described above, but have a drink instead of the extinguisher piece of candy. The drink may be juicy and/or sweet drink that reduces the sourness. Alternatively, the extinguisher candy may be one or more sour tablets that dissolve in a glass of liquid to create drinks with different sourness levels and then a sugar tablet that dissolves into the liquid and reduces the sourness of the drink.

The extinguisher candy described above is a candy in which the levels of sourness of the pieces of candy are varied and the extinguisher piece of candy reduces the sourness. The extinguisher candy may also be created wherein each piece has a spicy/hot sensation wherein the pieces of candy have different levels of spiciness/hotness and the extinguisher piece reduces the spiciness/hotness of the pieces of candy. The same “game” as described above for the sour pieces of candy can also be played using these spicy pieces of candy.

While the foregoing has been with reference to a particular embodiment of the invention, it will be appreciated by those skilled in the art that changes in this embodiment may be made without departing from the principles and spirit of the invention, the scope of which is defined by the appended claims.

1. A food product, comprising:
two or more portions, each portion having an intensity level that is different from each other portion; and
an extinguisher portion, the extinguisher portion reducing the intensity level of the two or more portions when consumed after consumption of any one of the two or more portions.

2. The food product of claim 1, wherein the two or more portions further comprises a first portion having a predetermined intensity level, a second portion having a second predetermined intensity level higher than the first piece and a third portion having a third predetermined intensity level higher than the second portion.

3. The food product of claim 2, wherein the first, second and third portions and the extinguisher portion each further comprises a piece of gum, a candy, a fruit snack, a chewy snack, a savory snack or a hard candy.

4. The food product of claim 3, wherein the first portion of food product further comprises citric acid, wherein the second portion of food product further comprises citric and fumaric acids and wherein the third portion of food product further comprises tartaric, citric and fumaric acids.

5. The food product of claim 1, wherein the intensity level further comprises one of a sourness level and a spiciness level.

6. The food product of claim 2, wherein the first, second and third portions and the extinguisher portion are fortified with fruit juice or fruit.

7. The food product of claim 2, wherein the first, second and third portions and the extinguisher portion each have a liquid center portion surrounded by an outer wall portion.

8. The food product of claim 2, wherein the first, second and third portions and the extinguisher portion each have a core portion and an outer layer portion that covers the core portion.

9. The food product of claim 8, wherein the core portion for the first, second and third portions further comprises an acid that sets the intensity level of the respective portion.

10. The food product of claim 8, wherein the outer layer portion for the first, second and third portions further comprises an acid that sets the intensity level of the respective portion.

11. The food product of claim 2, wherein the first, second and third portions and the extinguisher portion are formed as a continuous strip.

12. The food product of claim 2, wherein the first, second and third portions and the extinguisher portion are formed as a continuous strip of gum.

13. The food product of claim 2, wherein the first, second and third portions are each individual pieces and wherein the extinguisher portion is an individual piece.

14. The food product of claim 1, wherein the extinguisher portion further comprises a drink.

15. The food product of claim 2, wherein the first, second and third portions are tablets that dissolve in a liquid to form a sour drink.

16. A method for manufacturing a food product having two or more portions with different intensity levels, the method comprising:
mixing one or more ingredients to form a core portion wherein the one or more ingredients further comprises citric acid and a food starch;
permitting the core portions to rest in order to reduce cold flow of the core portions; and
forming a plurality of outer layers around the core portion to form a food product with two or more portions having different intensity levels, wherein the intensity level for each portion depends on the one or more acids that are part of the outer layers for the particular portion of the food product.

17. The method of claim 16 further comprising forming an extinguisher portion that extinguishes the intensity level of the two or more portions with the different intensity levels.

18. The method of claim 16, wherein mixing the one or more ingredients further comprises forming a different core portion for each of the two or more portions of the food product.

19. The method of claim 16, wherein mixing the one or more ingredients further comprises forming a single core portion that is used for all of the two or more portions.

20. The method of claim 16, wherein forming the plurality of outer layers further comprises hard panning the core portion to form the plurality of outer layers.

21. The method of claim 20, wherein the hard panning further comprises applying an acid based layer to the core portion to affect the intensity level of the two or more portions.

22. A method for playing a game using two or more portions of food product having different intensity levels and an extinguisher portion, the method comprising:
consuming at least one of the portions of the food product having a predetermined intensity level; and
extinguishing the intensity level of the at least one of the portions of the food product having a predetermined intensity level by consuming the extinguisher portion.
